(19) United States
(12) Patent Application Publication
(10) Pub. No.: US 2019/0218099 A1
(43) Pub. Date: Jul. 18, 2019

(54) NANOFIBER SHEET ASSEMBLY

(71) Applicant: Lintec of America, Inc., Richardson, TX (US)

(72) Inventor: Chi Huynh, Richardson, TX (US)

(73) Assignee: Lintec of America, Inc., Richardson, TX (US)

(21) Appl. No.: 16/242,086

(22) Filed: Jan. 8, 2019

Related U.S. Application Data
(60) Provisional application No. 62/617,674, filed on Jan. 16, 2018.
(60) Provisional application No. 62/681,772, filed on Jun. 7, 2018.

(51) Int. Cl. C01B 32/168; D01F 9/12

(52) U.S. Cl. CPC C01B 32/168; B32B 9/047; D01F 9/12

(57) ABSTRACT

Nanofiber sheet assemblies include at least one nanofiber sheet and at least one nanofiber grid or web that is used to improve the physical durability of the nanofiber sheet within the assembly. Nanofiber sheet assemblies retain the permeability of the nanofiber sheets to gaseous phase substances. This enables technological applications of nanofiber sheet assemblies to include filters for micron or nano-scale particles that are disposed in gas phase substances.

### TECHNICAL FIELD

The present disclosure relates generally to nanofibers. Specifically, the present disclosure is related to nanofiber sheet assemblies.

### BACKGROUND

A “forest” of nanofibers or carbon nanotubes refers to an array of nanofibers or carbon nanotubes that are arranged substantially parallel to one another on a substrate and are oriented substantially perpendicular to a surface of the substrate. Nanofiber forests can be formed in any of a variety of ways, including growing the nanotubes by placing catalyst particles on a growth substrate, heating the substrate and catalyst particles in a furnace, and supplying a fuel compound to the heated catalyst and substrate. Nanofibers grow, often vertically, from the catalyst particles into a substantially parallel array. A nanofiber forest can be drawn into a sheet of nanofibers.

### SUMMARY

Example 1 includes a method for processing a nanofiber sheet, the method comprising: providing a solution of water and an organic solvent to a suspended nanofiber sheet; and exposing the suspended nanofiber sheet to droplets of the solution of water and the organic solvent, wherein the exposing causes a freestanding portion of the suspended nanofiber sheet to contract.

Example 2 includes the subject matter of Example 1, further comprising exposing the contracted suspended nanofiber sheet to droplets of an additional solution of water and an additional organic solvent, wherein the additional solution has a higher concentration of the additional organic solvent than the solution of water and the organic solvent, the exposing causing further contraction of the freestanding portion; and exposing the further contracted freestanding portion to droplets of an organic solvent that includes less than 2 volume % water.

Example 3 includes the subject matter of Example 2, wherein exposing the suspended nanofiber sheet to droplets of the solution of water and the organic solvent causes the suspended nanofiber sheet to contract into nanofiber bundles having a first diameter.

Example 4 includes the subject matter of Example 3, wherein exposing the nanofiber bundles having the first diameter to droplets of the additional solution causes the nanofiber bundles having the first diameter to further contract to a second diameter less than the first diameter; and exposing the nanofiber bundles to droplets of the additional organic solvent that includes less than 2% water causes the nanofiber bundles having the second diameter to contract to a third diameter less than the second diameter.

Example 5 includes the subject matter of Example 4, wherein the first diameter is at least 7 μm and the third diameter is less than 3 μm.

Example 6 includes the subject matter of any of the preceding Examples, wherein, prior to the exposing, the nanofiber sheet comprises a plurality of nanofibers aligned in a common direction to form a continuous sheet in the freestanding portion.

Example 7 includes the subject matter of any of the preceding Examples, wherein the organic solvent in isopropyl alcohol.

Example 8 includes the subject matter of any of the preceding Examples, wherein the solution is 50 volume % water and 50% isopropyl alcohol.

Example 9 includes the subject matter of any Example 8 , wherein the exposing causes the nanofiber sheet to contract into a plurality of bundles of nanofibers defining a plurality of gaps having an average gap size of from 500 microns to 1000 microns.

Example 10 includes the subject matter of Example 8, wherein an average bundle diameter is from 5 μm to 15 μm.

Example 11 includes the subject matter of any of the preceding Examples, wherein the exposed nanofiber sheet has a transmittance of at least 86% for radiation having a wavelength of 550 nm.

Example 12 includes the subject matter of any of the preceding Examples, wherein the solution further comprises silver nanoparticles having an average diameter of 200 nm, and wherein the exposed nanofiber sheet has a transmittance of 99% of radiation having a wavelength of 550 nm.

Example 13 includes the subject matter of any of Examples 1-7, wherein the solution is 25 volume % isopropyl alcohol and 75 volume % water.

Example 14 includes the subject matter of any of Examples 1-7, 13, wherein the exposing causes the nanofiber sheet to contract into a plurality of bundles of nanofibers defining a plurality of gaps having an average gap size of from 600 μm to 1800 μm.

Example 15 includes the subject matter of any of Examples 1-7, 13, 14, wherein an average bundle diameter is from 12 μm to 100 μm.

Example 16 includes the subject matter of any of Examples 1-7 wherein the solution is 75 volume % isopropyl alcohol and 25 volume % water.

Example 17 includes the subject matter of any of Examples 1-7, 16, wherein the exposing causes the nanofiber sheet to contract into a plurality of bundles of nanofibers defining a plurality of gaps having an average gap size of 100 μm to 250 μm.

Example 18 includes the subject matter of any of Examples 1-7, wherein the solution is over 98% isopropyl alcohol.

Example 19 includes the subject matter of any of Examples 1-7, 18, wherein exposing the nanofiber sheet to the solution causes the freestanding portion of the nanofiber sheet to contract a thickness by a factor of 1000 while remaining continuous.

Example 20 includes the subject matter of any of Examples 1-7, 18, 19, wherein exposing the nanofiber sheet to the solution causes the freestanding portion of the nanofiber sheet to contract by densifying from at least 100 microns in thickness to less than 30 nm in thickness while remaining continuous.

Example 21 includes the subject matter of any of Examples 1-20, further comprising applying nanoparticles to the densified freestanding portion of the nanofiber sheet, the densified freestanding portion of the nanofiber sheet remaining continuous after applying the nanoparticles.

Example 22 includes the subject matter of any of Examples 1-21, wherein the nanofiber sheet comprises a first nanofiber sheet and a second nanofiber sheet, and further wherein the first nanofiber sheet comprises a discontinuous nanofiber sheet having plurality of nanofiber bundles defining a corresponding plurality of intervening gaps, and the second nanofiber sheet comprises a continuous nanofiber sheet disposed on the discontinuous nanofiber sheet.

Example 23 includes the subject matter of Example 22, further comprising applying another nanofiber sheet to the discontinuous nanofiber sheet on a side opposite the continuous nanofiber sheet.

Example 24 includes the subject matter of any of Examples 1-23, wherein the exposing comprises exposing the nanofiber sheet to droplets of the solution provided at ambient pressure and from 20° C. to 30° C.

Example 25 includes the subject matter of any of Examples 1-24, further comprising suspending nanoparticles in the solution prior to the exposing, wherein the exposing further comprises exposing the nanofiber sheet to the solution that includes the nanoparticles.

Example 26 includes the subject matter of any of Examples 1-25, wherein the nanofiber sheet comprises a first nanofiber sheet comprising a first contracted freestanding portion and a second nanofiber sheet comprising a second contracted freestanding portion, and further wherein the first nanofiber sheet is stacked on the second nanofiber sheet to overlap the first contracted freestanding portion and the second contracted freestanding portion.

Example 27 includes the subject matter of Example 26, wherein the nanofibers of the first nanofiber sheet are oriented in a first direction, the nanofibers of the second nanofiber sheet are oriented in a second direction different from the first direction thus forming a stacked nanofiber assembly.

Example 28 includes the subject matter of Example 27, wherein the first direction and the second direction are orthogonal.

Example 29 includes the subject matter of any of the preceding Examples, further comprising exposing the suspended nanofiber sheet to pure IPA vapor prior to exposing the suspended nanofiber sheet to the solution of water and the organic solvent, wherein exposing the suspended nanofiber sheet to pure IPA causes the nanofiber sheet to densify without forming gaps or bundles.

Example 30 includes the subject matter of any of the preceding Examples, wherein exposing the suspended nanofiber sheet to droplets of the solution comprises an aerosol of the solution.

Example 31 includes the subject matter of any of the preceding Examples, further comprising mounting peripheral edges of the nanofiber sheet to a frame to form the suspended nanofiber sheet, the nanofiber sheet having an adhered peripheral edge overlapping the frame and the freestanding portion within the frame.

Example 32 includes the subject matter of any of the preceding Examples, wherein the solution is pure IPA with an equilibrium amount of water from humidity in an ambient atmosphere.

Example 33 is a method for processing a nanofiber sheet, the method comprising suspending in a frame at least two nanofiber sheets separated by a gap and having a first pitch; and exposing the suspended nanofiber sheets to droplets of a solvent, wherein the exposing causes a freestanding portion of the suspended nanofiber sheets to contract into a bundle and be separated by a second pitch.

Example 34 includes the subject matter of Example 33, further comprising producing the at least two nanofiber sheet strips by treating a nanofiber forest, the treating comprising exposing nanofibers of the forest to a laser to form a strip of treated nanofibers separating a first strip of untreated nanofibers and a second strip of untreated nanofibers, wherein the first strip and the second strip have the first pitch.

Example 35 includes the subject matter of Example 34, wherein the strip of nanofibers exposed to the laser is not drawn into a nanofiber sheet.

Example 36 includes the subject matter of any of Examples 33-35, wherein the solvent is an aerosol of 100% water.

Example 37 includes the subject matter of any of Examples 33 to 36, wherein the solvent is an aerosol of 100% water.

Example 38 includes the subject matter of any of Examples 33 to 37, wherein the gap is from 1 mm to 4 mm.

Example 39 includes the subject matter of any of Examples 33 to 38 wherein a ratio of a diameter of the bundle to the pitch is from 0.003 to 0.005.

Example 40 is a method comprising treating a nanofiber forest to include a region of the nanofiber forest that cannot be drawn into a forest, the region separating a first strip and a second strip of the nanofiber forest at a first pitch; drawing the first strip and the second strip into a first nanofiber sheet and a second nanofiber sheet at the first pitch; mounting the first nanofiber sheet and the second nanofiber sheet onto a frame; and exposing the first nanofiber sheet and the second nanofiber sheet to a solvent to form a first grid of a first nanofiber bundle and a second nanofiber bundle, the first nanofiber bundle and the second nanofiber bundle at a second pitch.

Example 41 includes the subject matter of Example 40, further comprising repeating the method of Example 36 to form a second grid.

Example 42 includes the subject matter of Example 41, further comprising placing the first grid on the second grid to form an assembly.

Example 43 includes the subject matter of any of Examples 40-42, wherein the first pitch is from 0. 5 mm to 1 cm.

Example 44 includes the subject matter of any of Examples 40 to 43, wherein the second pitch is between 2000 μm to 2100 μm.

Example 45 includes the subject matter of any of Examples 40 to 44, wherein the solvent is an aerosol of water, the exposing comprising using compressed air to form the aerosol.

Example 46 is a nanofiber assembly comprising: a first nanofiber grid comprising a first nanofiber bundle and a second nanofiber bundle aligned with the first nanofiber bundle, the first nanofiber bundle having a first bundle average diameter and separated from the second nanofiber bundle by a first average pitch, the first nanofiber bundle having a ratio of a first bundle average diameter to the first average pitch of from 0.0001 to 0.0048; a second nanofiber grid on the first nanofiber grid, the second nanofiber grid comprising a third nanofiber bundle aligned with a fourth nanofiber bundle, the third nanofiber bundle separated from the fourth nanofiber bundle by a second average pitch, the third nanofiber bundle having a second bundle average diameter and having a ratio of a second bundle average diameter to the second average pitch of from 0.0001 to 0.0048; and a nanofiber sheet on the second nanofiber grid, wherein an angle between the first nanofiber bundle and the third nanofiber bundle is between 30° and 90°.

Example 47 includes the subject matter of Example 46, wherein the first average bundle diameter and the second bundle average diameter are each from 2 μm to 11 μm.

Example 48 includes the subject matter of either Examples 46-47, wherein one or more of the first pitch and the second pitch is from 950 μm to 2400 μm.

Example 49 includes the subject matter of any of Examples 46-48, wherein: one or more of the first pitch and the second pitch is from 935 μm to 975 μm; and one or more of the first bundle diameter and the second bundle diameter is from 1.8 μm to 2.0 μm.

Example 50 includes the subject matter of any of Examples 46-49, wherein the first pitch and the second pitch are from 1 mm to 2 mm.

Example 51 includes the subject matter of any of Examples 46-50, wherein the first bundle diameter and the second bundle diameter are from 1.8 μm to 2.0 μm.

Example 52 includes the subject matter of any of Examples 46-51, wherein transmittance of radiation projected normally through the nanofiber assembly and having a wavelength of from 10 nm to 125 nm is more than 90%.

Example 53 includes the subject matter of any of Examples 46-52, wherein the radiation is transmitted at a power of from 100 Watts to 250 Watts.

Example 54 includes the subject matter of any of Examples 46-53, wherein intensity of transmitted radiation having a wavelength of from 10 nm to 125 nm over an area of the nanofiber assembly having a length of 100 mm and a width of 150 mm has a 3a variation of less than 0.5.

Example 55 includes the subject matter of any of Examples 46-54, wherein transmittance of radiation projected normally through the assembly and having a wavelength of 13.5 nm is more than 90%.

Example 56 includes the subject matter of any of Examples 46-55, wherein specular scattering of radiation having a wavelength of 13.5 nm is less than 1%.

Example 57 includes the subject matter of any of Examples 46-56, wherein the assembly has a length of from 90 mm to 110 mm and a width of from 140 mm to 155 mm.

Example 58 includes the subject matter of any of Examples 46-57, further comprising a frame attached to a perimeter of the nanofiber assembly.

Example 59 includes the subject matter of any of Examples 46-58, further comprising silver nanoparticles disposed within the first nanofiber bundle, the second nanofiber bundle, the third nanofiber bundle, and the fourth nanofiber bundle, the silver nanoparticles having a diameter of 50 nm or less.

Example 60 includes the subject matter of any of Examples 46-59, further comprising gaps defined by the second nanofiber grid on the first nanofiber grid having a dimension of from 10 μm to 25 μm.

Example 61 includes the subject matter of any of Examples 46-60, wherein transmittance through the assembly of radiation having a wavelength of 550 nm is at least 86%.

Example 62 includes the subject matter of any of Examples 46-61, further comprising silver nanoparticles having an average diameter of from 100nm to 250 nm, and wherein the nanofiber assembly has a transmittance of 99% of radiation having a wavelength of 550 nm.

### BRIEF DESCRIPTION OF THE DRAWINGS

FIG. 1A is a plan view of a nanofiber sheet, in an embodiment.

FIG. 1A′ is a plan view of a nanofiber grid, in an embodiment.

FIG. 1B is a side view of the nanofiber sheet of FIG. 1A, in an embodiment.

FIG. 1C is a side view of the nanofiber grid of FIG. 1A′, in an embodiment.

FIG. 2A is a plan view of a nanofiber sheet assembly that includes a nanofiber sheet in contact with a nanofiber grid, in an embodiment.

FIG. 2B is a side view of the nanofiber sheet assembly of FIG. 2A, in an embodiment.

FIG. 2C is a side view of an example nanofiber sheet assembly, in an embodiment.

FIG. 3 is a method flow diagram illustrating an example method for making a nanofiber sheet assembly, in an embodiment.

FIGS. 4A -4F illustrate various views of a nanofiber sheet assembly fabricated according to the example method illustrated in FIG. 3, in embodiments.

FIG. 5A is a plan view of a nanofiber mesh usable as a component in a nanofiber sheet assembly, in an embodiment.

FIGS. 5B and 5C are scanning electron microscope (SEM) photomicrographs of a nanofiber mesh, in some embodiments.

FIGS. 6A and 6B illustrate schematic side views of nanofiber sheet assemblies, in embodiments.

FIG. 7 is a method flow diagram illustrating an example for fabricating a nanofiber sheet assembly, in an embodiment.

FIG. 8 is a method flow diagram illustrating an example method for preparing a filter to be used with extreme ultra-violet (EUV) radiation, in an embodiment.

FIG. 9 is a method flow diagram illustrating another example method for preparing a filter to be used with EUV radiation filter, in an embodiment.

FIGS. 10A-10D are schematic illustrations of some stages of fabrication corresponding to the example method illustrated in FIG. 9, in embodiments.

FIG. 11 is a photomicrograph of an example forest of nanofibers on a substrate, in an embodiment.

FIG. 12 is a schematic illustration of an example reactor for nanofiber growth, in an embodiment.

FIG. 13 is an illustration of a nanofiber sheet that identifies relative dimensions of the sheet and schematically illustrates nanofibers within the sheet aligned end-to-end in a plane parallel to a surface of the sheet, in an embodiment.

FIG. 14 is an SEM photomicrograph is an image of a nanofiber sheet being laterally drawn from a nanofiber forest, the nanofibers aligning from end-to-end as schematically shown in FIG. 13, in an embodiment.

The figures depict various embodiments of the present disclosure for purposes of illustration only. Numerous variations, configurations, and other embodiments will be apparent from the following detailed discussion. Furthermore, as will be appreciated, the figures are not necessarily drawn to scale or intended to limit the described embodiments to the specific configurations shown. For instance, while some figures generally indicate straight lines, right angles, and smooth surfaces, an actual implementation of the disclosed techniques may have less than perfect straight lines and right angles, and some features may have surface topography or otherwise be non-smooth, given real-world limitations of fabrication processes. In short, the figures are provided merely to show example structures.

### DETAILED DESCRIPTION

### Overview

Nanofiber sheets can, in some cases, be permeable to gases and gas mixtures (e.g., air, argon, nitrogen) even when the sheets are a continuous structure. However, these continuous sheets may be impermeable to solid or liquid particles. This can enable a nanofiber sheet to function as a filter for solid phase particles or liquid phase droplets that are present in a gas phase. However, because nanofiber sheets are generally physically fragile and will often wrinkle, distort, or tear when contacted by airborne particles or even disturbed by air currents (e.g., from air handling equipment, movement of objects), nanofiber sheets have not generally been used in filters.

Techniques are disclosed herein that can overcome some aspects of the physically delicate nature of nanofiber sheets, thus enabling nanofiber sheet assemblies to be used for filtering liquid phase and solid phase particles from a gas phase. Embodiments of nanofiber sheet assemblies disclosed herein not only improve the physical durability of nanofiber sheets, but also simultaneously preserve the permeability of the nanofiber sheets to gaseous phase substances which would be inhibited by placing a nanofiber sheet on a conventional substrate, such as a continuous polymer sheet or a continuous glass sheet. Furthermore, techniques are disclosed herein that improve the physical stability of nanofiber sheets, thus improving their durability under a variety of conditions and a variety of technological applications.

Some embodiments of the present disclosure include techniques for forming a nanofiber sheet assembly from at least two nanofiber sheets. One or more of the nanofiber sheets in the nanofiber sheet assembly can be exposed to vapor and/or aerosol droplets of a solution of at least two different solvents. This can produce a nanofiber grid or a nanofiber web, which can in turn be used to improve the mechanical stability of a second nanofiber sheet placed thereon. It will be appreciated that the terms vapor and aerosol are used interchangeably and equivalently here, with the understanding that under certain conditions these different phases of matter can produce the same results either alone or in combination with one another.

The at least two solvents can be selected based on the chemistry, surface energy, and/or hydrophobicity of the nanofiber sheet(s). In some examples, the solution includes isopropyl alcohol (IPA) and water. The composition of the solution (e.g., the relative proportions of IPA and water) can be selected to control nanofiber sheet thickness, surface topography, an extent to which a nanofiber sheet forms bundles of grouped nanofibers, and an average size and/or shape of gaps between bundles of group nanofibers (“bundles” for simplicity). In some examples, pure water droplets provided under pressure and at ambient temperatures (e.g., 20° C.-25° C.) can produce large longitudinal gaps between fiber bundles in the nanofiber sheet. In some examples, pure water droplets provided at ambient pressure (i.e., not accelerated with a pressurized gas) at temperatures between 80° C. and 100° C. can produced densified nanofiber sheets that are not bundled and do not include gaps. In some examples pure IPA can be applied so as to densify (i.e., increase a density of a sheet without causing bundles and gaps to form) a nanofiber sheet. Densifying a sheet, whether through water steam droplets or IPA droplets can reduce a thickness of a nanofiber sheet by as much as a factor of 1000 while also preserving the physical continuity of the nanofiber sheet (i.e., no gaps are formed as a result of the densifying). In some examples, increasing amounts of water in solution with IPA will generally increase the gap sizes when provided at temperatures less than 30° C. and at pressures greater than 2 psi.

Depending on the structure of the nanofiber sheets processed to form nanofiber grids (e.g., parallel bundles of nanofibers separated by elongated quasi-rectangular or square gaps) or webs (e.g., networks of interconnected bundles of nanofibers separated by gaps of irregular polygons), in which bundles of nanofibers are separated by spaces, particles as small as 0.5 microns, 0.1 microns, 0.05 microns, or 0.005 microns in diameter can be captured by embodiments of the present disclosure. In some examples, two or more webs and/or grids can be placed on top of one another in different orientations. These examples can produce a nanofiber mesh with a gap size having a smaller width, length, and/or area than a gap size found in a single sheet and/or grid.

In other techniques of the present disclosure, vapor droplets of the solution of at least two different solvents can also be formulated to include any of a variety of nanoparticles. The resulting nanofiber sheet assemblies processed according to the techniques described herein can have a combination of high radiation (including optical light) transmittance and mechanical durability that is uncommon for single layer nanofiber sheets or nanofiber sheet assemblies fabricated by other methods. As a result of this mechanical durability combined with radiation and gas transmissibility, nanofiber sheet assemblies of the present disclosure can therefore be used for high optical light transmittance gas filters or substrates. Nanofiber sheets of the present disclosure also exhibit high radiation transmittance, transmitting as much as 80% or more of incident radiation. In some examples, radiation transmitted through some embodiments of the present disclosure can polarize light. Unless otherwise described, radiation transmission is measured as the amount of radiation passing through a substrate when transmitted in a direction perpendicular (normal) to the average plane of the substrate.

In other techniques of the present disclosure, a nanofiber assembly can be fabricated by “scoring” lines in a nanofiber forest or strips in the nanofiber forest that cannot be spun into nanofiber yarn. This scoring can be performed by, for example, using a laser or a mechanical or thermal treatment of the forest. These “unspinnable” regions separate regions of nanofiber forest that can be spun into nanofiber yarns. This technique can be used to control width of the nanofiber bundles resulting from the spinnable strips as well as the spacing (or “pitch”) between nanofiber bundles in a nanofiber assembly.

Equivalently, embodiments herein may be referred to as nanofiber filters, nanofiber pellicles, and/or nanofiber membranes.

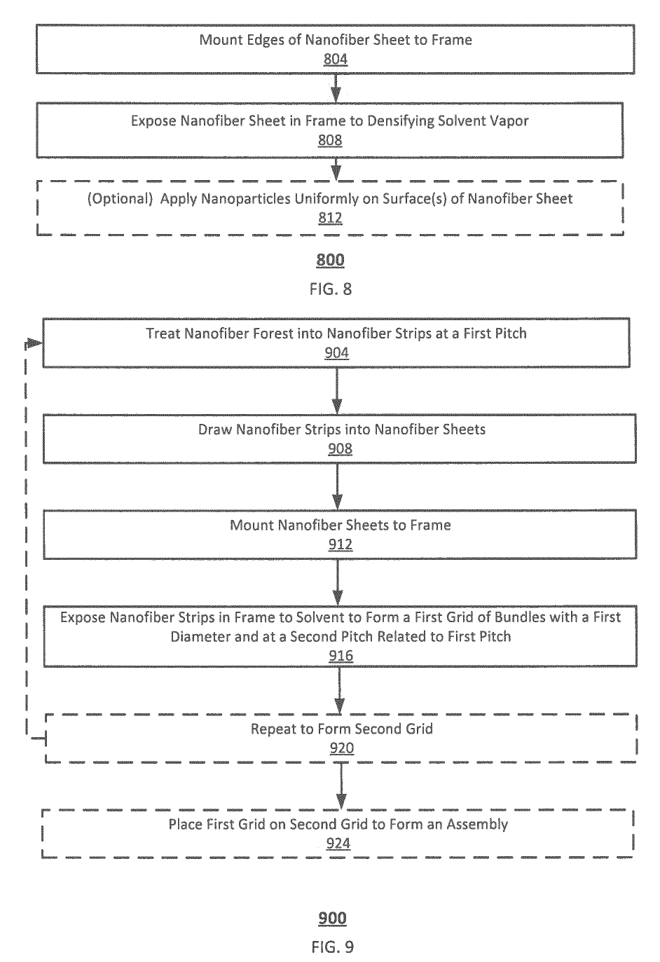

Information regarding nanofibers, nanofiber forests, and nanofiber sheets is presented in the context of FIGS. 8-14, which follows the description of the nanofiber sheet assemblies in the context of FIGS. 8-10.

### Example Nanofiber Sheet Assembly Structures

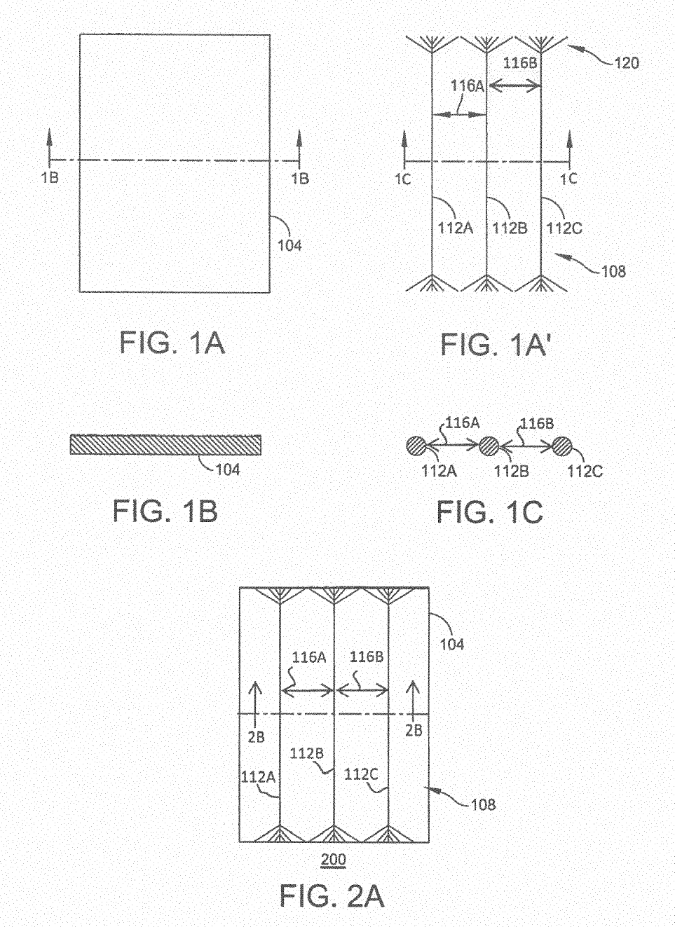

FIGS. 1A, 1A′, 1B, and 1C illustrate various views of example components used in a nanofiber sheet assembly of the present disclosure. FIG. 1A illustrates top views of a first nanofiber sheet 104 and FIG. 1A′ illustrates a top view of nanofiber bundles of a nanofiber grid 108 (formed from a second nanofiber sheet) The nanofiber sheet 104 and the nanofiber grid 108 can be assembled together to form nanofiber sheet assemblies, in some embodiments. Note that these figures, and others described below, have been drawn to emphasize clarity of explanation and are not drawn to scale.

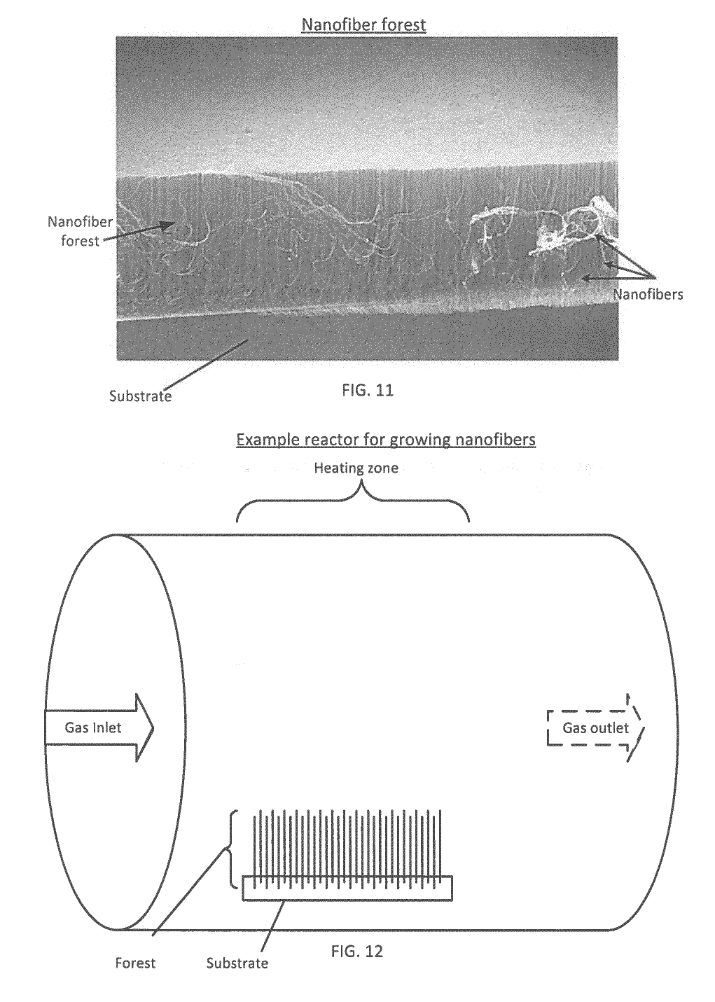

The nanofiber sheet 104 can be fabricated from a nanofiber forest according to methods described below in the context of FIGS. 11-14. As shown in FIGS. 1A, 1A′, 1B, and 1C, the nanofiber grid 108 includes a plurality of nanofiber bundles 112A, 112B, 112C (collectively, 112) defining intervening gaps 116A and 116B (collectively, 116). The nanofiber bundles 112A, 112B, 112C are connected to an outer perimeter via bundle groups 120. The bundle groups 120 are formed as nanofibers in a precursor nanofiber sheet transition to an arrangement of nanofiber bundles 112. For example, in one embodiment, a nanofiber sheet (distinct from, but analogous to the nanofiber sheet 104) can be processed into the nanofiber grid 108 by mounting or connecting a peripheral edge of the precursor nanofiber sheet to a frame. In one example, the frame acts as a mask that prevents exposure of the peripheral edge of the precursor nanofiber sheet to subsequent processing (e.g. solvent vapor) while at the same time enabling an interior portion of the precursor nanofiber sheet to be freestanding (i.e., not physically supported by any other structure and supporting its own weight). In another example, the frame stabilizes the peripheral edge of the precursor nanofiber sheet, thus preventing contraction of the nanofiber sheet at the peripheral edge when the sheet is exposed to a solvent vapor (or vapor of an organic solvent/water solution). The freestanding portion of the nanofiber sheet can then be exposed to droplets and/or particles in the one or more solvents. This exposure causes the formation of the nanofiber bundles 112 and intervening gaps 116, as described below in more detail.

Cross-sectional views of both the nanofiber sheet 104 and the nanofiber grid 108 are shown in FIGS. 1B and 1C, which are not drawn to scale but rather drawn to facilitate explanation.

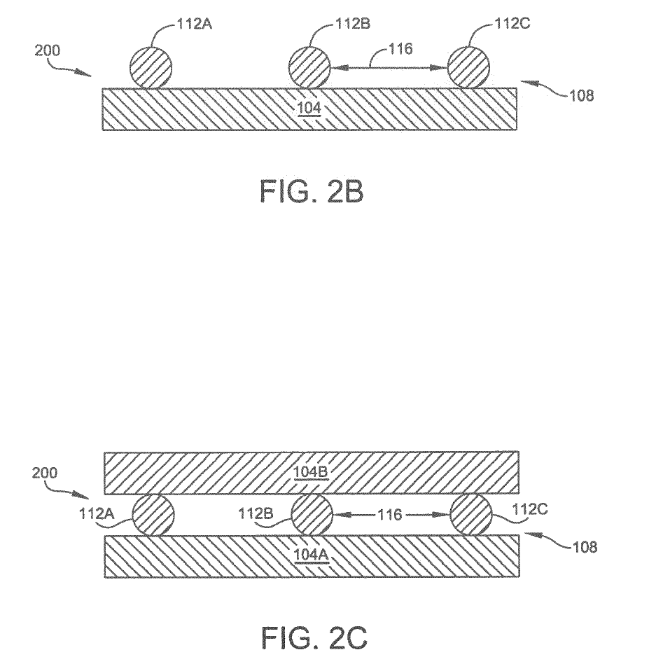

FIGS. 2A, 2B, and 2C illustrate top and cross-sectional views of various nanofiber sheet assemblies of the present disclosure. Some examples of nanofiber sheet assemblies the present disclosure can be formed by combining elements analogous to those illustrated in FIGS. 1A, 1A′, 1B, and 1C. For example, FIG. 2A illustrates a top view of a nanofiber assembly 200. The nanofiber assembly 200 includes a nanofiber grid 108 and a nanofiber sheet 104. Both of these elements have been described above. These two elements are placed in contact with one another to form the nanofiber assembly 200. In some examples, the interface may be free of adhesive and mere physical contact is sufficient to form the assembly 200 because the nanofiber grid 108 and the nanofiber sheet 104 adhere to one another without the addition of another force, structure or composition. In other examples, an adhesive can be placed between the nanofiber grid 108 and the nanofiber sheet 104 to encourage a firm connection. In still other examples, a material (such as a polymer or adhesive) can be infiltrated into one or both of the nanofiber grid 108 and the nanofiber sheet 104 so as to encourage a firm connection. A portion of the nanofiber assembly 200 is shown in cross-section in FIG. 2B.

In some examples, the nanofiber grid 108 can act as a structural support for the nanofiber sheet 104. This structural support can prevent the otherwise fragile nanofiber sheet 104 from becoming torn, damaged, or unintentionally bundled in response to an external perturbation (e.g., contact with an air current or particles suspended in a gas). In one example, the nanofiber grid 108 helps maintain the continuity of the nanofiber sheet 104 by physical contact between the bundles 112 of the grid 108 and the nanofiber sheet 104. The physical contact enables the bundles 112 of the grid 108 to provide a stabilizing force to the nanofiber sheet 104 that can counter-act the tendency of the nanofiber sheet 104 to wrinkle, fold, and/or tear in response to perturbations. The nanofiber grid may include openings that are more or less than 2×, more or less than 10×, more or less than 100× or more or less than 1000× the area of the average gap of the nanofiber sheet being supported.

As indicated above, the stability added to the nanofiber sheet 104 from contact with the grid 108 enables the nanofiber assembly 200 to be used as a filter that allows gas to flow through the nanofiber sheet 104 but prevents particulate matter from passing through the nanofiber sheet 104. Furthermore, because the nanofiber assembly 200 has a high transmissivity to many wavelengths of radiation, not only can the nanofiber assembly 200 effectively prevent transmission of even nano-sized particles from one side of the assembly to the other, it can permit transmission of over 85%, 90%, or 95%, of some wavelengths of incident radiation. This combination of effective filtration of nano-sized particles and high transmissivity is advantageous in any number of technological applications and industries.

FIG. 2C illustrates a cross-sectional view of another embodiment of an example nanofiber sheet assembly 204. The nanofiber sheet assembly 204 has many elements in common with the nanofiber assembly 200. For example, the nanofiber sheet assembly 204 includes two nanofiber sheets 104A and 104B, separated by, and in contact with, an intervening nanofiber grid 108. The inclusion of two nanofiber sheets, as shown in FIG. 2C, can improve filtration rate (i.e., improve a reduction in airborne particle concentration from one side of the nanofiber sheet assembly relative to the other), improve mechanical stability (i.e., reducing the likelihood of damage per unit time of operation or an increase in the particle size or impact force the nanofiber sheet assembly is able to withstand without damage), without a significant reduction in radiation transmittance.

### Nanofiber Sheet Assembly Formation Techniques

The mechanical durability of a nanofiber sheet assembly, such as those illustrated herein, is at least proportional to the mechanical support provided by a nanofiber grid (or analogous structure, such as a nanofiber web or a nanofiber mesh as described below). However, forming a nanofiber grid having a desired spacing between bundles or having a desired bundle diameter (both of which can affect the mechanical stability of a nanofiber sheet assembly) can be difficult. Often, the exposure of a nanofiber sheet to water or an organic solvent produces an uncontrolled contraction of the previously continuous nanofiber sheet. This uncontrolled contraction produces a nanofiber grid that forms bundles and corresponding gaps of highly variable dimensions (e.g., a mixture of irregular polygons, circles, ovals). This high variability can reduce the effectiveness of the filtration as well as increase the yield loss during manufacturing due to nanofiber grids that have too large or too variable a gap size to be suitable for a desired application.

To overcome this processing variability, techniques disclosed herein include the use of solutions of solvents that can produce nanofiber grids having selectable bundle diameters and gap widths. The selected dimensions can be produced in response to a composition of the solution applied, in combination with one or more of the temperature of the applied solution, a velocity of particles or vapor droplets of the applied solution, an average size of the vapor droplets, heat capacity of the applied solution, and/or a duration of exposure of a nanofiber sheet to particles or vapor droplets of the applied solvent solution. Composing a solution and selecting other process parameters (e.g., time of exposure, droplet velocity, droplet temperature) so as to select a gap size and/or bundle diameter enables the formation of nanofiber sheet assemblies with more predictable mechanical stabilities, more consistent gap sizes, more predictable transmittance to radiation, and more predictable particulate filtration effectiveness.

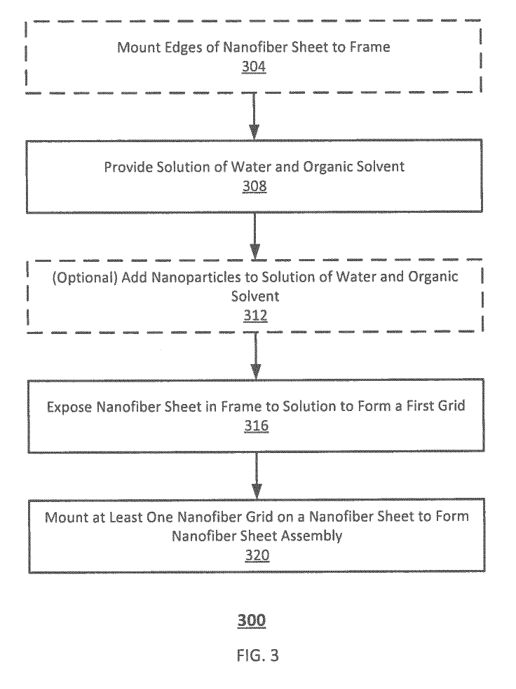

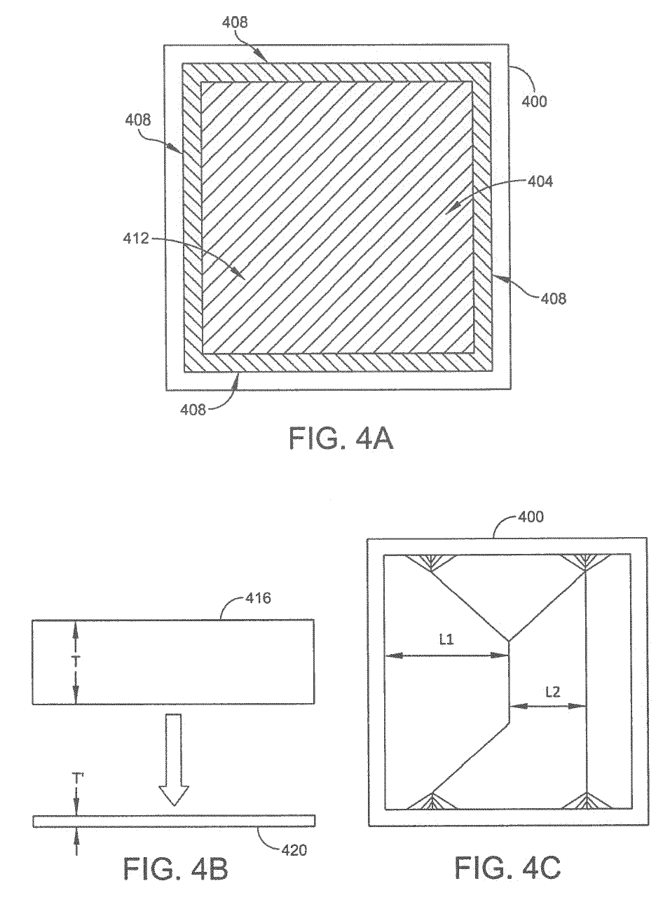

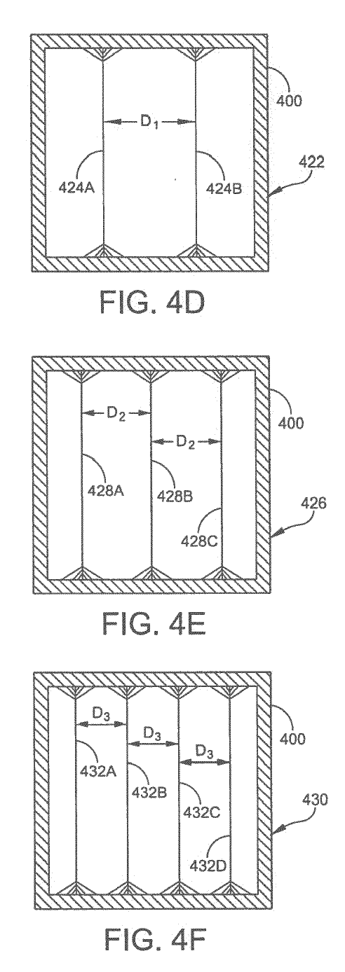

FIG. 3 illustrates one example method 300 for producing nanofiber sheet assemblies having selectable nanofiber bundle diameters, gap widths, and bundle configurations (e.g., a grid, a web, a mesh, or combinations thereof), in some embodiments of the present disclosure. Corresponding figures FIG. 4A to 4F illustrate example configurations presented to facilitate explanation of the method 300.

Method 300 begins by optionally mounting 304 peripheral edges of a nanofiber sheet to a frame or otherwise fixing some or all of opposing edges of the nanofiber sheet to resist contraction toward one another during subsequent processing. This configuration is illustrated in FIG. 4A. As shown, the frame 400 and the nanofiber sheet 404 are mounted together. This mounting creates a mounted peripheral edge 408 that overlaps with the frame 400. A freestanding portion 412 is within the peripheral edge 408.

The optional mounting 304 (or other fixing of some or all of opposing edges) of the nanofiber sheet can be performed in any of a number of ways. In one example, the nanofiber sheet 404 naturally adheres to the frame 400 without any mechanical or chemical agent. In another example, the mounted peripheral edge 408 of the nanofiber sheet can be impinged between two mating portions of a frame, thus preventing contraction or movement of the peripheral edge 408 of the nanofiber sheet 404 during subsequent processing. In another example, the peripheral edge 408 of the nanofiber sheet 404 can be adhered to a frame (e.g., frame 400) using an adhesive, an adhesive film or tape, vacuum, electric charge, or some other means of adhesion. Regardless of the method of mounting, the mounting 304 prevents contraction or change in conformation of the mounted peripheral edge 408 of the nanofiber sheet 404 during processing. Mounting 304 also, for convenience of explanation, defines the freestanding portion 412 of the nanofiber sheet 404 within the frame 400. This freestanding portion 412 is not in direct contact with the frame 400 nor in contact with any other mechanical support, and thus is not constrained from bundling. The freestanding portion 412 is able to support its own weight without tearing, folding, or otherwise deforming into a non-planar shape. Other types of mounting 304 can include structures that are not a frame.

The method 300 continues by providing 308 a solvent or mixture of solvents. The solvent mixture may be a combination of any number of solvents and may include, for example, two, three or four different solvents. In one set of embodiments, one of the solvents is water and a second solvent is a water-miscible organic solvent. A water miscible organic solvent is an organic solvent that is soluble in water at greater than 1% volume at room temperature. Examples of water miscible solvents include polar protic and polar aprotic solvents. Specific classes of appropriate solvents include alcohols, aldehydes and glycols. In some cases, the miscible solvent is a low molecular weight alcohol such as isopropanol (IPA), ethanol (EtOH), methanol (MeOH), propanol, butanol or mixtures thereof. In particular cases, the solvent is a secondary alcohol such as isopropanol. The composition of the solution of water and the organic solvent can be selected based on the nanofiber bundle diameter and gap width desired for a nanofiber grid. In one example, the solution is pure IPA. In another example, the solution is a mixture of water and isopropyl alcohol (IPA). In another example, the solution is that of water and acetone. In still another example, the solution is pure water.

The solvent and/or solvents can be provided 308 to the nanofiber sheet using a variety of techniques. In some examples, technique(s) vary one or more of the temperature of the applied solution, a velocity of vapor droplets of the applied solution, an average size of the droplets of the applied solution (e.g., a diameter), and/or a duration of exposure of a nanofiber sheet to particles or vapor droplets of the applied solvent solution. For example, the liquid (solvent or solvents, plus any suspended particles) can be in the form of an aerosol that comprises droplets of the solvent (or solvent solution) suspended in air. The aerosol droplets can have an average diameter, for example, of less than 1 mm, less than 100 μm, less than 50 μm or less than 20 μm. The aerosol can be produced using, for example, a spray nozzle, micro bubbles, or ultrasound. In other cases, the nanofiber sheet can be placed in a container including a gaseous environment that is saturated with the solvent or solvents of interest. The solvent can be condensed onto the nanofiber sheet by, for example, cooling the environment or cooling the nanofiber sheet itself. In some embodiments, the nanofiber sheet can be cooler than the gaseous environment when it is introduced to the environment. In some cases, a mixture of gas phase solvents can be used. For example, both gaseous environment can include both water and IPA. In some cases, these solvent mixtures may co-condense onto the nanofiber sheet as an azeotrope.

In some examples, in addition to those factors described above, effects on nanofiber sheet structure (e.g., diameter of bundles, size of gaps between bundles, regularity of gap size) can be influenced by a temperature of the droplets of solvent as well the heat capacity of the solvent (or solvent solution). For example, it has been observed that vaporized water droplets (e.g., produced by heating water to 100° C.) that are provided at atmospheric pressure without an accelerant gas (i.e., “low velocity”) can densify a sheet without producing bundles and gaps, particularly for exposure times of less than 10 seconds, less than 5 seconds or less than 2 seconds. Instead, these “high temperature, low velocity” water droplets have been observed to improve the cohesiveness and tensile strength of nanofiber sheet. That is, once treated with the aforementioned “high temperature/low velocity” vaporized water droplets, the nanofiber sheets were densified, and more resistant to bundling and tearing. In some examples, this may be because of increased Van der Waals attraction between fibers within the densified sheet. This increase in strength can sometimes also be observed as smaller bundle diameters and smaller gap sizes than would be expected when the nanofiber sheet is subsequently treated with droplets that are more likely to produce bundling (e.g., droplets provided using pressurized gas).

While not wishing to be bound by theory, it is believed that in some examples the heat delivered by 100° C. water vapor at ambient pressure can improve the ability of a nanofiber sheet to be densified relative to lower temperature water vapor or vapors of solvents that have lower heat capacities/lower boiling points. In other words, more heat is transferred to a nanofiber sheet by a droplet of water than, for example, a droplet of IPA because the boiling point of water is 17.4° C. greater than IPA (100° C. vs. 82.6° C.) and the heat capacity of water is nearly 50% greater that of IPA (4.186 Joule/gram-° C. vs. 2.68 Joule/gram-° C. at 20° C.). This heat can encourage densification of the sheet, which can further increase sheet strength. As indicated above, lower temperature of the solvent droplets and lower velocity of solvent droplets also encourage densification of a nanofiber sheet and are less likely to produce bundling (or produce smaller diameter bundles and smaller gaps between bundles).

For convenience of explanation, the following description will focus on the example of water and IPA. It will be appreciated that solutions other than water and organic solvents can be applied to a nanofiber sheet, as described herein, without departing from embodiments of the present disclosure. Furthermore, it will be appreciated that the three solution compositions described in detail below are selected for convenience of description and that other compositions can be selected to produce analogous results.

In some experiments, it has been observed that the greater the relative portion of IPA to water, the smaller the resulting gap size within the nanofiber grid. At one extreme, pure IPA provided as a high temperature vapor at low vapor droplet velocity (i.e., IPA steam) has been observed to not form gaps within the nanofiber sheet within the frame, but rather to densify the freestanding portion nanofiber sheet and reduce the height of surface topography of the sheet. This is schematically illustrated in FIG. 4B in which a reduction in thickness T of a nanofiber sheet 416 to a densified nanofiber sheet 420 with a thickness T′ can be as much is by a factor of 1000 when exposed to a vapor of low velocity droplets (e.g., the vapor velocity is not accelerated by positive pressure but rather is due primarily to Brownian motion) of pure IPA (other than an equilibrium amount of water from humidity in the ambient atmosphere). It has been observed that the thickness of a nanofiber sheet can be reduced from 100 μm to as thin as 25 nm when processed by a pure IPA solution under conditions that are described below in more detail in the context of experimental examples shown in Table 1. Light transmittance is also improved significantly upon treatment with IPA and may increase by more than 50%, more than 75% or more than 90%. A similar effect has been observed for high temperature, low velocity water steam.

At the other extreme, pure water delivered at a temperature of between 0° C. and 20° C. and accelerated using pressure (e.g., using a gas pressurized from 1 psi to 5 psi) has been observed to form the largest gaps within the freestanding portion of the nanofiber sheet in the frame. This is schematically illustrated in the plan view of FIG. 4C, which illustrates relatively large and irregular gaps formed when a nanofiber sheet is exposed to water droplets. This type of nanofiber sheet having irregular gaps is referred to herein as a nanofiber “web.”

In still other examples, a first solvent or a first solution of solvents can be applied to the freestanding portion of the nanofiber sheet in the frame. Application of the first solvent or the first solution can be followed by one or more separate applications of different compositions of solvents or solutions of solvents. This technique can be repeated so that multiple applications of differently composed solvents and/or solutions of solvents gradually decrease a diameter of the bundles formed from the nanofiber sheet.

In one example, a first composition of a solution of 80% water and 20% IPA can be applied to the nanofiber sheet as an aerosol by a compressed gas (e.g., air, nitrogen, argon, carbon dioxide, and/or combinations thereof), causing the nanofiber sheet to form nanofiber bundles as described elsewhere herein. A second composition, a solution of equal parts water and IPA (i.e., 50% IPA and 50% water), can be applied as an aerosol to the bundles formed from application of the first composition. A third composition, of approximately 100% IPA (e.g., at least 98% IPA, or with an equilibrium amount of water dissolved in the IPA from the surrounding atmosphere), can be applied as an aerosol to the bundles formed from application of the second composition. The second composition, and the third composition, when applied to nanofiber bundles initially formed from the application of the first composition as described above, can progressively decrease a diameter of nanofiber bundles. In an experimental example in which a first, a second, and a third composition were each composed as described above (80% water and 20% IPA; 50% water and 50% IPA; 100% IPA), it was found that nanofiber bundles formed after application of the first composition had a diameter of 7 μm. It was also found in this experimental example that the diameter decreased to 2 μm after application of the third composition of pure IPA.

Optionally, nanoparticles may be added 312 to the solution of water and the organic solvent. Nanoparticles, when added 312 to the nanofiber sheet as a dispersion in the solvent, can increase the size of gaps defined by the nanofiber bundles, increase electrical conductivity of the nanofiber sheet within the frame, and increase resistance to mechanical damage of the nanofiber sheet, among other benefits. Furthermore, because the nanoparticles can form a colloidal suspension within the solution, only an initial agitation is required to disperse and suspend the nanoparticles. Illustrative examples of nanoparticles that can be added 312 to the solution include nano flakes, nano rods, and spherical nano particles of any of a variety of metals including, but not limited to silver, copper, gold, iron, nickel, neodymium, platinum, palladium, graphene, graphene oxide, fullerenes, small organic molecules, polymers, oligomers, ceramic sol gel precursors, among others. In some cases, the particles become encased in the bundled nanofibers, isolating the particles from exposure to the environment that can cause, for example, oxidation.

In other embodiments, a material can be dissolved in the solvent, rather than being suspended or dispersed. For example, a soluble silver salt such as silver nitrate can be dissolved in water, IPA, or a combination thereof An aerosol of the silver nitrate solution can be contacted with the nanofiber sheet, depositing the silver nitrate on the nanofibers. The silver nitrate can then be reacted in situ to produce, for example, metallic silver. In some other examples, in situ reactions (including those involving strong acids, bases, and/or temperatures up to 350° C.) can be performed on and/or within nanofiber sheets to form coatings and/or nanoparticles on and/or within the nanofiber sheet.

In another example, large bundles (e.g., 10 μm or greater) can be produced by sequential exposure of the sheet to a first solution predominantly of water and then to a second solution of predominantly IPA, both of which can be provided as droplets accelerated by pressurized gas (e.g. air, Ar, or N₂). In one example, the first solution of water (or a solution of at least 80% water and another solvent) at ambient temperature (e.g., between 20° C. and 25° C.) is provided to a nanofiber sheet using gas pressurized between 2 psi or 40 psi to cause formation of bundles and gaps. As indicated above, generally, the higher the concentration of water, the higher the pressure of gas used to accelerate the droplets of water, and/or the lower the temperature of the applied droplets, the larger and more uniform the gaps and bundles are. A second solution of IPA (or a solution of at least 80% IPA and another solvent) is provided to the nanofiber bundles. The second solution can be composed of any solvent having a higher vapor pressure than water that is soluble with water. Exposure of the bundled nanofiber sheet to the second solution facilitates removal of any residual water in the nanofiber bundles from the first solution. This removal of water can improve the bundle strength by causing a further reduction in bundle diameter and a resulting increase in the strength of inter-fiber Van der Waals forces.

In examples in which the nanofiber sheet 404 is mounted 304 to a frame, the nanofiber sheet 404, and more specifically the freestanding portion 412, is exposed 316 to the provided solution. Upon exposure 316 to the solution (in any of the forms described above in the providing 308 element of the method 300), the freestanding portion 412 of the nanofiber sheet 404 can form bundles and gaps as described above to form a first nanofiber grid or web. As is also described above, the bundle diameters and the gaps defined by the bundles have sizes and shapes corresponding to, for example, the relative proportion of water to organic solvent, the composition of the organic solvent, the particle size of the dispersed particles, and the velocity of the solution droplets. Exposing 316 a nanofiber sheet to a solvent, of any composition, causes the nanofibers of the sheet to draw together, thus densifying the sheet. However, depending on a number of factors, this densification may not be uniform across a freestanding portion of the nanofiber sheet. That is, the sheet can densify uniformly (as illustrated in FIG. 4B) or non-uniformly. Non-uniform densification can result in nanofiber bundling that forms the gaps illustrated in FIGS. 4C-4F, among others. For example, uniformity across a freestanding portion of a nanofiber sheet is generally improved when using a taller nanofiber forest (as measured from a growth substrate to an exposed surface of the forest on the growth substrate). For example, a nanofiber forest 200 microns or more in height produces a more uniform freestanding portion than a nanofiber forest 100 microns in height.

Some of the factors that can contribute to determining nanofiber bundle diameter, gap size between nanofiber bundles, and the configuration of the bundles themselves are provided below. For example, as shown above in FIG. 4B, application of pure IPA using a low velocity IPA steam can in some examples merely densify the nanofiber sheet, leaving the nanofiber sheet continuous and non-bundled. Densifying a sheet in this way can improve the tensile strength, durability and/or reduce the gap (and/or mesh) size of any of the components of a nanofiber sheet assembly of the present disclosure. It has been shown that in solutions of IPA and water where the IPA concentration is 50 volume (vol.) % or greater and the temperature is between 20° C. and 25° C., the nanofiber sheet can form a web, such as the one illustrated in FIG. 4C. Average widths L1 and L2 of the gaps shown in the web of FIG. 4C can vary in some examples within any of the following ranges: between 50 μm and 100 μm; between 5 μm and 500 μm; between 100 μm and 1000 μm; from 250 μm to 750 μm; from 750 μm to 1000 μm; from 10 μm to 25 μm; from 10 μm to 50 μm; from 50 μm to 100 μm. A standard deviation of any of the preceding ranges can be between any of the following: from 50 μm to 100 μm; from 10 μm to 250 μm; from 100 μm to 500 μm. For solutions of IPA and water where the IPA concentration is less than 50 vol. % (i.e., the water concentration is greater than 50 vol. %), the structure changes from a web to a grid, like those shown in FIGS. 4D, 4E, and 4F. Unlike the webs illustrated in FIG. 4C, the grids shown in FIGS. 4D, 4E, and 4F are characterized by approximately parallel bundles of nanofibers that define intervening gaps. FIG. 4D illustrates one example of a nanofiber grid 422 produced by exposure to a solution with a high concentration of water (e.g., greater than 75% by volume) and a relatively low concentration of IPA (e.g., less than 25% by volume). In this example, the nanofiber bundles for 424A and 424B (formed by exposure of the nanofiber sheet to the solution) are separated by a gap of dimension D1. In some examples, D1 can be within any of the following ranges: from 400 μm to 2500 μm; from 1000 μm to 2000 μm; from 800 μm to 2200 μm; from 600 μm to 2000 μm. The standard deviation of these average widths D1 can be, for example, from 500 μm to 800 μm. In some embodiments, the diameter of the bundles 424A, 424B can be from 5 μm to 25 μm. In another example illustrated in FIG. 4E, the concentration of IPA and water is approximately equal at 50 volume % each (within +/−5%). In this example, the number of nanofiber bundles increases 428A, 428B, 428C and the spacing D2 of the gaps between the nanofiber bundles decreases. For example, the spacing of the gaps D2 can be from 100 μm to 2000 μm in the diameter of the nanofiber bundles 428A, 428B, 428C can be from 5 μm to 20 μm. In still another example, the IPA concentration can be 75 vol. % and the water concentration can be 25 vol. %. In this example, the solution causes a nanofiber sheet to form a grid 430 rather than a web, in which bundles 432A, 432B, 432C, and 432D are separated by gaps having a width of D3. In examples, D3 can be from 1 μm to 250 μm and the diameters of the bundles 432A, 432B, 432C, and 432D from 5 μm to 15 μm.

In addition to composition of the solution, other factors may influence the average diameter of the nanofiber bundles and the average gap size defined by the nanofiber bundles. Included among these factors are the density of the nanofiber sheet exposed to the solution (e.g., mass/volume or number of nanofibers/volume), the thickness of the nanofiber sheet, and the average droplet size and droplet size distribution of the vapor.

Another factor is the velocity at which the solution droplets are provided to the nanofiber sheet. Generally, it has been observed that droplets of vapor exposed to a nanofiber sheet that are supplied with positive pressure (i.e., having a velocity greater than that associated with Brownian motion of the molecules at between 20° C. and 30° C.) produce larger gaps between nanofiber bundles. For example, when the nanofiber sheet is sealed in a chamber with vapor whose droplets have only the speed attributed to Brownian motion associated with an ambient temperature (e.g. between 20° C. and 30° C.), the formation of nanofiber bundles within the sheet, and the associated gaps, is reduced or eliminated even though the nanofiber sheet is thinned dramatically (as indicated above, for example, by a factor of as much as 1000).

Generally, higher velocity of droplets contacting the nanofiber sheet, larger the droplets contacting the nanofiber sheet, higher water concentration in droplets of a solution contacting the nanofiber sheet, and lower density of the nanofiber sheet all tend to increase a gap size between nanofiber bundles.

In another example, the nanofiber sheet can be treated with a series of sequentially applied solutions, each of which has a lower concentration of water. This can have the effect of facilitating removal of water from the bundles that are initially formed by contact between the nanofiber sheet and the solution of water and a solvent. Sequentially exposing the grid to solutions with progressively lower water content can also have the effect of reducing the diameter of the nanofiber bundles. For example, the nanofiber sheet can be treated with a solution of 80% water and 20% IPA, thus forming nanofiber bundles into a nanofiber grid as described above. Then, the nanofiber bundles of the grid can be exposed to a solution of 50% water and 50% IPA. After this exposure, the nanofiber bundles of the grid can be further exposed to a solvent free of water, such as 100% IPA or 100% acetone, for example. Residual water within the nanofiber bundles of the grid (previously deposited by a solution with a higher water content) can solvated by the IPA (or acetone) and removed upon evaporation of the IPA (or acetone). An experimental example of this process is described below. Other solutions applied to a nanofiber sheet and grid in successively decreasing proportions of water can include combinations of one or more of ethylene glycol, IPA, and water. In still other examples, the bundles treated with any one or more of the solutions described herein can be heated in an oven and/or processed within a vacuum chamber or both, to remove the applied solvent(s), which can further reduce a bundle diameter.

At least one nanofiber grid can be mounted or stacked 320 on a nanofiber sheet to form a nanofiber sheet assembly, as described above. In some examples, more than at least one additional grid (or web) can be stacked on a first nanofiber grid (or web) to form a nanofiber mesh. The orientation of the nanofiber bundles of the additional grid can be, in examples, parallel to, perpendicular to, or at an angle between 0° and 90° relative to the orientation of the nanofiber bundles of the first grid. In some examples, nanofiber sheets and/or nanofiber grids (or arrays) can be stacked at an angle of 30° relative to one another to minimize scattering of incident radiation and increase transmittance. In some other examples, the stacked nanofiber sheets and/or nanofiber grids can be aligned in a same direction (based on a direction of constituent nanofibers) so as to enhance one direction of radiation polarization. In some examples, the stacked nanofiber sheets and/or nanofiber grids can be oriented 90° relative to one another in a stack to enhance orthogonal directions of radiation polarization.

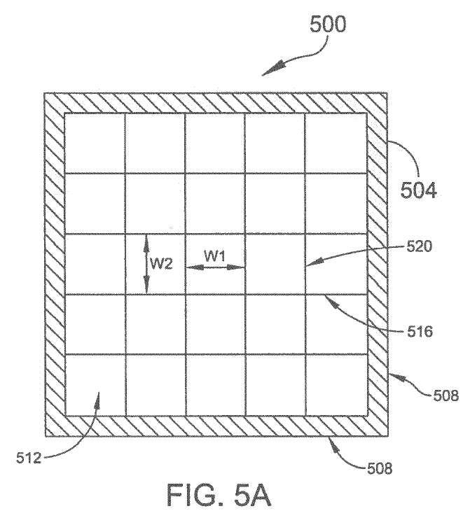

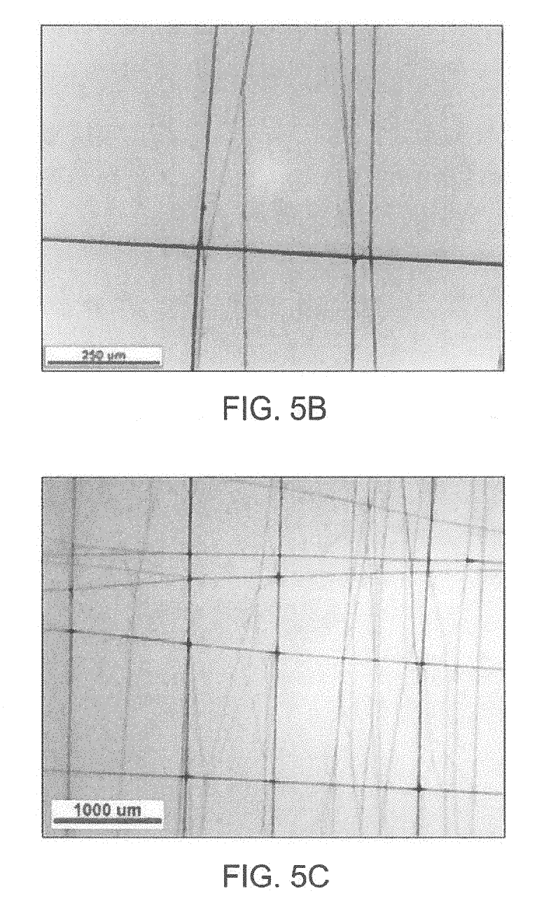

An illustration of two stacked grids appears in FIG. 5A. As shown, the assembly 500 includes a freestanding portion 512 suspended in a frame 504, a mounted peripheral edge 508, a first nanofiber grid 516 (with bundles oriented horizontally) and a second nanofiber grid 520 (with bundles oriented vertically). In the example illustrated in the FIG. 5A the two nanofiber sheets are oriented so that the bundles form an orthogonal array of nanofiber bundles. In some examples, a dimension of the gaps W1, W2 defined by the bundles can be within any of the following ranges: from 10 μm to 25 μm; from 25 μm to 75 μm; from 200 μm to 1500 μm; from 500 μm to 1000 μm; from 200 μm to 1100 μm; from 300 μm to 1000 μm. SEM photomicrographs of experimental example grids appear in FIGS. 5B and 5C. It will be appreciated that the rectangular and/or square gaps illustrated and shown in FIGS. 5A, 5B, and 5C are not required but are merely for purposes of illustration, and that combinations of nanofiber webs (having gaps that are irregular shapes and/or irregular polygons) may produce gaps of many different shapes. The stacking of additional nanofiber grids can result in the effective reduction of the gap size and/or gap shape. For example, when three grids of similar average gap size are stacked at an angle of 120° to each other, the particle size retention (when the grid is used as a filter) may be, for example, 10%, 20% or 30% smaller when compared to two of the same grids arranged orthogonally. Furthermore, the shape of gaps associated with three stacked grids may be triangular or an irregular polygon (as opposed to predominantly rectangular and/or square).

The first nanofiber grid 516 and the second nanofiber grid 520 can either be formed independently from one another using the techniques described above, or the first nanofiber grid 516 and the second nanofiber grid 520 can be formed sequentially. That is, the first nanofiber grid 516 can be used as a substrate onto which a precursor nanofiber sheet is placed. The techniques described above can then be used to transform the precursor nanofiber sheet into the second nanofiber grid 520.

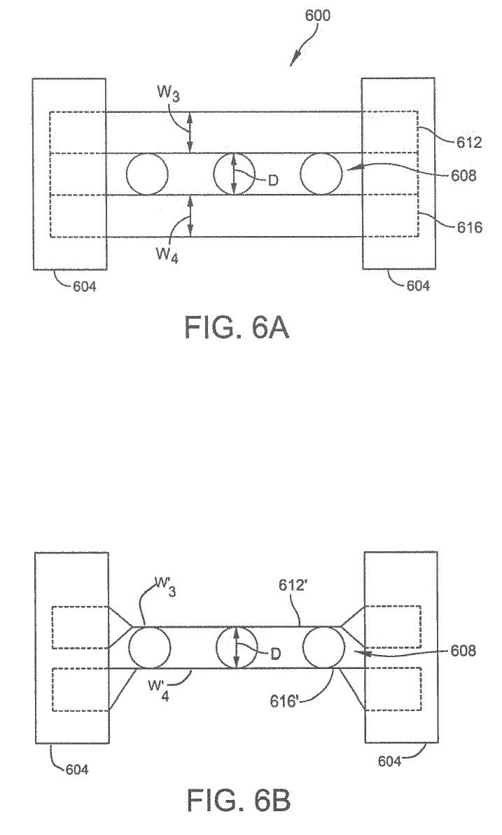

In an alternative variation of the embodiment shown in FIGS. 5A, 5B, and 5C, a nanofiber grid can be formulated according to the techniques described above and nanofiber sheets can be attached to either side of the nanofiber grid. This is schematically depicted in cross-sectional views FIG. 6A and FIG. 6B. As shown, the assembly 600 includes a nanofiber grid 608 (or array), a frame 604, and nanofiber sheets 612, 616.

The nanofiber grid 608 can be prepared using any of the techniques described herein. For example, a nanofiber sheet that is a precursor to the nanofiber grid 608 can be exposed to a solution of water and an organic solvent (e.g., IPA) so as to cause the precursor nanofiber sheet to contract into a plurality of bundles having a diameter D (the values of which are also described elsewhere herein), thus forming the nanofiber grid 608. The nanofiber sheets 612, 616 having a thickness W₃ and W₄, respectively, are then placed on opposing sides of the nanofiber grid 608. One or both of the nanofiber sheets 612, 616 can be exposed to, for example, low velocity droplets of IPA (e.g., pure IPA) so as to cause the thickness to be reduced to W₃′ and W₄′ for the modified sheets 612′, 614′ that, as described above, can be as much as 1000 times thinner than W₃ and W₄. Furthermore, the nanofiber sheets 612, 616 can be rendered insulative or conductive to alter the electrical characteristics of the assembly. For example, silver particles can be deposited to improve conductivity or the sheet can be coated with an insulative polymer to increase electrical resistance.

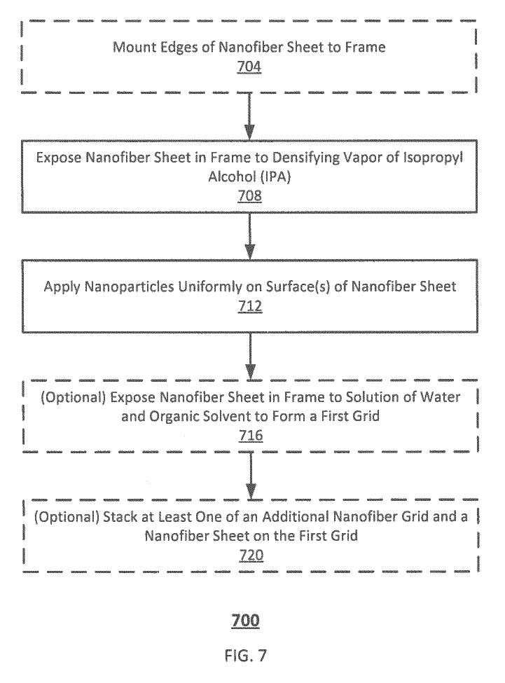

In an alternative method 700, illustrated in FIG. 7, edges of a nanofiber sheet are mounted 704 to a frame (or fixed/immobilized to another structure), as described above. The nanofiber sheet is then exposed 708 to droplets of pure IPA vapor (e.g., including no more than an equilibrium amount of water in the IPA from the ambient atmosphere) having a low velocity (e.g., supplied with no positive pressure). As described above, pure IPA, and in particular, droplets of low velocity pure IPA, can cause the nanofiber sheet to densify and not bundle (as illustrated in FIG. 4B). Because nanofiber sheets that are more dense can provide webs or grids that have smaller gap sizes compared to those produced from less dense sheets, an IPA densified sheet can be used to produce nanofiber assemblies that have smaller gaps and are more durable to external perturbations, thus improving the utility of the assemblies as filters. While not indicated in FIG. 3, it will be appreciated that this densification is equally applicable to the example method 300.

In one embodiment, nanoparticles can be uniformly applied 712 on the surface(s) of the nanofiber sheet. In one example, this is accomplished by suspending the nanoparticles in IPA or other solvent prior to exposing 708 the nanofiber sheet and then vaporizing or otherwise creating a low velocity aerosol of the nanoparticle IPA suspension. The nanoparticles include any of those previously described. The combination of IPA and the low velocity of IPA suspension droplets enables the nanoparticles to be deposited, in many cases, uniformly over one or more surfaces of the nanofiber sheet in the frame without causing bundling of the nanofiber sheet.

The nanofiber sheet on which the nanoparticles are uniformly disposed can then be exposed 716 to a solution of water and an organic solvent, as described above. This forms a nanofiber grid that, as described above, can act as a grid or mechanical support that inhibits bundling, tearing, or the formation of holes or other discontinuities in the nanofiber sheet. The composition of the solution can be selected according to the degree of nanofiber sheet bundling (or in other words, the degree of radiation transmittance) desired. For example, a solution of approximately equal parts of IPA and water (e.g., 50 vol. % IPA and 50 vol. % water) can be provided to form gaps within any of the previously described ranges. Alternatively, pure water can also be provided to form gaps of within any of the previously described ranges. It will be appreciated that increasing the velocity with which the droplets are provided will increase bundling and radiation transmittance (e.g., optical light transmittance). It will also be appreciated that other compositions of solutions, whether of varied proportions of water and IPA or solutions composed of entirely different solvents, can be applied without departing from the scope of the present disclosure. As also described above, at least one additional nanofiber grid and/or nanofiber sheet can be stacked 720 on the grid.

### EXPERIMENTAL EXAMPLES

The following experimental results in Table 1 and Table 2 illustrate the effect of IPA/water solution composition on various aspects of forming a nanofiber grid.

TABLE 1

| | | | Post |
|---|---|---|---|
| Number of | | | Treatment |
| Nanofiber | Solvent Composition/ | Orientation | Transmittance |
| Sheets | Process | of Sheets | (λ = 550 nm) |
| 1 | Untreated carbon | N/A | 80% |
| | nanofiber sheet | | |
| | (Control Sample) | | |
| 1 | Equal parts IPA | N/A | 86% |
| | and water (1:1) | | |
| 1 | Pure IPA + Ag | N/A | 99% |
| | nanoparticles | | |
| 2 | Pure IPA + Ag | Sheets stacked | 98% |
| | nanoparticles | perpendicular to | |
| | | one another | |
| 3 | First and second | Sheets stacked | 86% |
| | sheets exposed | alternating | |
| | individually to pure | perpendicular | |
| | IPA, then provided | orientations | |
| | with Ag nanoparticles, | | |
| | then stacked. Third | | |
| | sheet stacked on | | |
| | first and second | | |
| | sheet, then exposed | | |
| | to steam of | | |
| | 1:1::IPA:water | | |

TABLE 2

| Solution | Avg. Gap | | Bundle Avg. | Light |
|---|---|---|---|---|
| Composition | Size (μm) | Gap Std. | Diameter (μm)/ | Transmit- |
| (vol. % IPA/ | (Structure | Deviation | Std. Deviation | tance (%)/ |
| vol. % water) | Type) | (μm) | (μm) | Std. Dev. |
| 100/0* | 55 (web) | 53 | | 85/1.3 |
| 75/25* | 91 (web) | 130 | | 89.6/1.3 |
| 75/25 | 96 (web) | 98 | | 86.4/0.4 |
| 50/50* | 97 (web) | 106 | | 99.4/0.5 |
| 50/50 | 536 (grid) | 562 | 9/4 | 99.3/0.6 |
| 25/75 | 1102 (grid) | 571 | 14/3 | 99.4/0.5 |
| 25/75 | 1237 (grid) | 641 | 15/96 | 99.5/0.4 |
| 0/100 | 1435 (grid) | 709 | 16/4 | 99.3/0.7 |

Samples in Table 2 denoted with an asterisk (*) were exposed to a densifying vapor of pure IPA (corresponding to element 708 of the method 700) prior to being exposed to the solution of the composition listed in Table 2. As described above, exposing a nanofiber sheet to a vapor of IPA to densify the sheet increases the density of the sheet, which in turn produces smaller gap sizes (and makes the structure more likely to be a web) upon subsequent exposure to a solution.

### Extreme Ultra-Violet (EUV) Radiation Transparent Nanofiber Filters

In some embodiments, a nanofiber assembly of the present disclosure can be fabricated in an alternative example method to produce a nanofiber filter that prevents transmission of nano-scale particles (e.g., less than 150 nm, less than 100 nm, less than 50 nm, and/or less than 30 nm in diameter or length) while also transmitting more than 75%, more than 80%, more than 85%, more than 90%, or more than 95% of an incident intensity of radiation having wavelengths from 10 nm to 125 nm (often referred to as “extreme UV,” “EUV,” or “XUV”). In one example, more than 75%, more than 80%, more than 85%, more than 90%, or more than 95% of incident intensity of 13.5 nm radiation is transmitted. Furthermore, nanofiber filters prepared according to this alternative example method can also be mechanically durable enough to withstand a pressure differential from one side of the filter to another of 1 atmosphere and/or vibrations of on the order of 500 Hz while maintaining sufficient integrity to maintain the EUV and filtration properties described above. In some examples, a nanofiber filter of the present disclosure that is at least 100 mm×150 mm will flex less than 1 mm, less than 0.5 mm, less than 0.3 mm, or less than 0.1 mm in response to a pressure of from 1 Pa to 5 Pa as measured from a greatest extent of protrusion to an unprotruded reference plane (e.g., a coplanar portion of a frame to which the nanofiber filter is connected). In some embodiments, a nanofiber filter of the present disclosure can filter particles less than 200 nm, less than 175 nm, or less than 150 nm in diameter (or length if the particle is not spherical or ellipsoidal in shape). In some embodiments, a nanofiber filter of the present disclosure can transmit more than 80% of “deep ultraviolent” or “DUV” incident radiation (which includes wavelengths between 10 nm and 400 nm, including excimer lasers with wavelengths of 248 nm and/or 193 nm). In some embodiments, a nanofiber filter of the present disclosure can transmit more than 75%, more than 80%, more than 85%, or more than 90% of infra-red (“IR”) incident radiation (which includes, e.g., a wavelengths of from 700 nm to 1 mm). In some embodiments, a nanofiber filter of the present disclosure can transmit any combination of EUV, DUV, and/or IR intensities described above. Variation in transmitted intensity (quantified as “3σ” variation) across a nanofiber filter of the present disclosure in any one or more of the wavelengths indicated above (EUV, DUV, IR) can be less than 0.5, 0.2, or 0.1. Furthermore, incident radiation can be transmitted at a power level of at least 100, Watts, 150 Watts, 200 Watts, 250 Watts, or more.

FIG. 8 is a method flow diagram illustrating an example method 800 for preparing an EUV filter, as described above. The method 800 begins by mounting 804 edges of a nanofiber sheet to a frame, as described above in the context of FIG. 7 and the example method 700. The mounted nanofiber sheet is then exposed 808 to a solvent vapor. In various examples, the solvent can be 100% IPA (with an equilibrium amount of water from the ambient atmosphere); 100% water; or a solution of IPA to water in any of the following volume ratios: 80:20; 50:50; 20:80; 10:90, or ratios therebetween. Exposing 808 the nanofiber sheet can be performed using the methods described above in some embodiments. In other embodiments, exposing 808 the nanofiber sheet can be performed by vaporizing the solvent or solution of solvents using heat (e.g., temperatures equal to or greater than the boiling point of the solvent and/or solution of solvents). In some cases, the thermally created vapor can be accelerated toward the nanofiber sheet using a compressed gas (e.g., compressed air, compressed nitrogen, compressed, argon) at 1 psi, 5 psi, 10 psi, 20 psi or values therebetween. Generally, the pressure should be high enough to accelerate the vapor droplets but not so high as to cause bundling or tearing of the nanofiber sheet. Experimentally, it was found that the steam of pure water (i.e., at least 100° C.) that was used to expose the nanofiber sheet at either atmospheric pressure or accelerated by as much as 1 psi-1.5 psi compressed gas did not cause bundling of the nanofiber sheet, but rather only caused the nanofiber sheet to densify. As explained above, while not wishing to be bound by theory, steam (i.e., vapor from boiling water) can provide heat to a nanofiber sheet, causing it to densify rather than bundle. Similarly, steam/vapor of solutions of IPA and water in a ratio of no more than 20 vol. % IPA to at least 80 vol. % water did not cause bundling but rather caused densification that reduced a thickness of the pre-densified sheet by as much 25%. Both of these treatments were observed as increasing tensile strength of the nanofiber sheet, and increasing resistance to bundling in subsequent treatments. Nanoparticles may be optionally applied 812 to the sheet, as described above.

FIG. 9 is a method flow diagram illustrating another example method 900 for preparing an EUV filter, as described above. In some examples, EUV filters prepared according to the method 900 have reduced scattering of EUV radiation (i.e., higher EUV intensity transmission) relative to continuous, densified nanofiber sheets while still providing filtration of nano-scale particles. In some examples EUV scattering at 13.5 nm is less than 1%, less than 0.5%, or less than 0.25% of incident radiation.

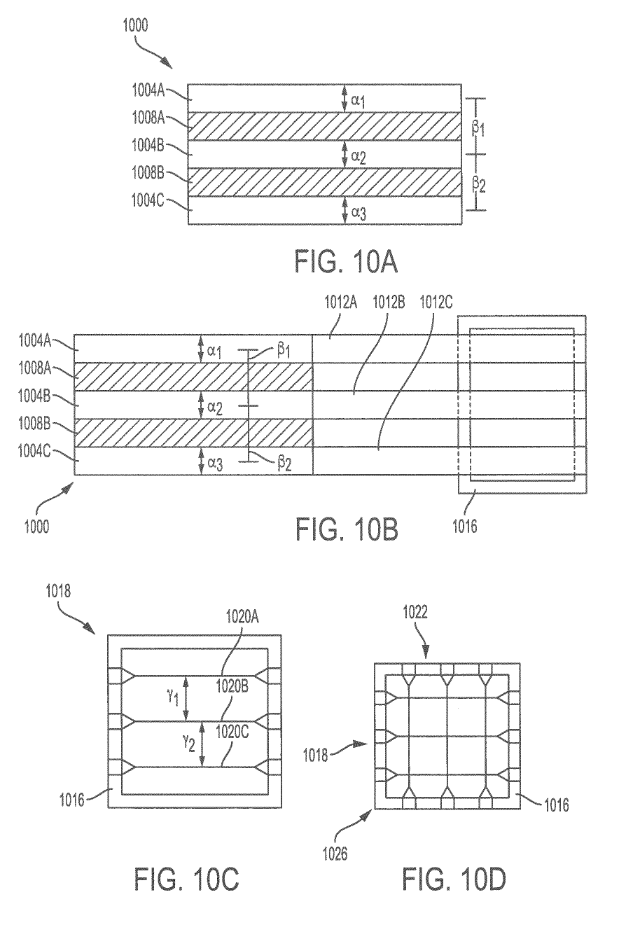

The method 900 begins by treating 904 a nanofiber forest so that the nanofiber forest includes regions of nanofibers that cannot be drawn into a nanofiber sheet. These treated regions that cannot be drawn into nanofiber sheets alternate with parallel strips of nanofiber forest that can be drawn into nanofiber sheets using forest synthesis and sheet drawing techniques described below. An example treated forest 1000 is shown in a plan view in FIG. 10A. The example forest 1000 includes strips of nanofiber forest that can be drawn into a nanofiber sheet-like strips 1004A, 1004B, and 1004C. Alternating with the strips 1004A, 1004B, and 1004C are regions 1008A, 1008B of the forest 1000 that have been treated 904 so as to be undrawable into a sheet. Treating 904 the forest 1000 so as to create these undrawable regions 1008A, 1008B can include burning nanofibers in the regions 1008A, 1008B with a laser or other heat source, mechanically disturbing the nanofibers in the regions 1008A, 1008B, among other techniques. Once treated 904, the regions 1008A, 1008B cannot be drawn into a nanofiber sheet. It will be appreciated that treating 904 need not be limited to laser and/or burning treatment, but rather can include any treatment technique that can prevent the regions 1008A, 1008B from being drawn into a sheet.

The drawable strips 1004A, 1004B, and 1004C can have widths α1, α2, α3 respectively and be at a first pitch (a center to center distance) of β1, β2, respectively. In examples, the widths α1, α2, α3 can be within any of the following ranges: from 0.5 mm to 10 cm; from 0.5 mm to 1 cm; from 0.5 mm to 3 cm; from 5 cm to 10 cm. In examples, the first pitches β1, β2 can be within any of the following ranges: from 0.5 mm to 10 cm; from 0.5 mm to 1 cm; from 0.5 mm to 3 cm; from 5 cm to 10 cm. In some examples, the ratio of a width of a drawable strip (e.g., a width of any one of 1004A, 1004B, 1004C) to a width of an undrawable region (1008A, 1008B) is 1:1. In other examples a ratio of the widths of drawable to undrawable strips can be 2:1, 3:1, or greater. In other examples, this ratio can be inverted so that a width of the undrawable strip is greater than that of a drawable strip. For example, a width of a drawable strip can be 1 mm and an undrawable strip can be 1 mm (i.e., a ratio of 1:1). In another example, a width of a drawable strip can be 500 μm and an undrawable strip can be 1500 μm (i.e., a ratio of 1:3).

Nanofiber sheets are then drawn 908 from the drawable nanofiber strips 1004A, 1004B, 1004C using techniques for drawing nanofiber sheets described below. This is illustrated in FIG. 10B, which show the strips 1004A, 1004B, 1004C drawn into nanofiber sheet-like strips 1012A, 1012B, 1012C. As is also shown in FIG. 10B, the treated 904 regions 1008A, 1008B are not drawn into nanofiber sheets as a result of the treatment, described above. FIG. 10B also shows the nanofiber strips 1012A, 1012B, 1012C mounted 912 on a frame 1016. This mounting 912 and the frame 1016 are analogous to those described above in the context of FIGS. 3, 4A, and 5A among others.

The nanofiber strips 1012A, 1012B, 1012C mounted 912 on the frame 1016 are then exposed 916 to a solvent to form a first grid 1018 of nanofiber bundles. This is illustrated in FIG. 10C. As described above, exposing 916 the nanofiber strips 1012A, 1012B, 1012C causes the strips to contract and densify, particularly upon removal of the solvent (or a solution of solvents, as described above) into bundles 1020A, 1020B, and 1020C. The second pitch between the bundles 1020A, 1020B, and 1020C, indicated in FIG. 10C as γ1 and γ2, is a function of the pitch β1, β2, respectively. Similarly, a diameter of the bundles 1020A, 1020B, and 1020C is a function of the width α1, α2, α3 of the corresponding sheets 1004A, 1004B, and 1004C. The diameter of the bundles and the second pitch γ1 and γ2 are also a function of a height of the nanofiber forest from which the bundles 1020A, 1020B, 1020C are drawn. Generally, the shorter the nanofibers in the nanofiber forest, the smaller the diameter of the bundles and the greater the pitch γ1 and γ2 between adjacent bundles 1020A, 1020B, 1020C. For example, a nanofiber forest having nanofibers with a height of 286 μm can produce bundles at a larger second pitch and with a smaller diameter than for a forest with nanofibers of 350 μm even with the first pitch between strips is the same in both forests. In some examples, the dimensions γ1 and γ2 can be within any of the following ranges: 20 nm to 300 nm; 20 nm to 150 nm; 20 nm to 100 nm; 50 nm to 300 nm; 50 nm to 200 nm; 50 nm to 150 nm; 100 nm to 300 nm; 100 nm to 200 nm; 200 nm to 300 nm.

This process can optionally be repeated 920 to form a second grid. As shown in FIG. 10D, the first grid 1018 can then be placed 924 in contact with the second grid 1022 to form an assembly 1026. While the first grid and the second grid are placed at a right angle to one another to form square gaps, it will be appreciated that the two grids can be placed at any angle to one another.

In one experimental example, a forest having a height of 120 μm (with a forest density of 45 grams/cm³) was treated using a laser to produce strips having a width of 2 mm separated by a line of unspinnable strips. It will be appreciated that generally forests having a height greater than 100 μm can be used. The forest was processed according the method 900 to produce a first grid. After exposing the strips to an aerosol of 100% water (generated by using compressed air of from 2 psi to 40 psi to form the aerosol), the grid had a bundle diameter of 9.9 μm and a pitch of 2050 μm (characterized as a width/pitch ratio of 9.9/2050=0.0048). In another similar example, 3 mm strips of spinnable forests were formed with a separating line of unspinnable forest to produce a width/pitch or “W/P” value of 11 μm/2624 μm=0.0042. In another experimental example, a forest having a height of 122 μm (with a forest density of 76 grams/cm³) was treated using a laser to produce strips having a width of 3 mm wide spinnable strips separated by a line of unspinnable forest. After exposing the strips to an aerosol of 100% water, the grid had a bundle diameter of 11 μm and a pitch of 2624 μm. This produced a bundle width/pitch ratio of 0.0042. In another example, a forest was treated with a laser to produce 1 mm wide spinnable strips with intervening 1.5 mm wide unspinnable tracks. When exposed to an aerosol of 100% water, the bundle diameter's W/P value was ˜5 um/2400 um (0.21%). It has generally been found that the lower the width/pitch ratio of bundles, the higher the EUV transmission and the lower the scattering of radiation. In some examples, UV light, ozone (O₃), plasma (e.g., argon plasma, oxygen plasma) can be used to treat the forest to change a relationship between a forest width (or strip width) and a diameter of a nanofiber bundle.

In another experimental example, a series of solutions was sequentially used to treat nanofiber sheets and bundles, wherein each solution in the series had a lower water content than the preceding solution applied to the nanofibers. This produced unusually small diameter nanofiber bundles at an unusually fine pitch. For example, a nanofiber sheet was processed according to the example shown and described in FIG. 10A so that the dimension a (i.e., width) corresponding to each strip was 250 μm and intervening non-spinnable portions were 750 μm (making the pitch β 1000 μm). These strips were drawn into multiple nanofiber sheets, according to the process shown and described above in the context of FIG. 10B. The nanofiber sheets were exposed to vapor of a solution of 80% water and 20% IPA. This caused the nanofiber sheet to contract into nanofiber bundles, thus forming a nanofiber grid as described above. The nanofiber grid was then exposed to a vapor of a second solution of 50% water and 50% IPA. The nanofiber grid was then exposed to a vapor of a third solution that was 100% IPA. As described above, this sequential exposure to solutions of decreasing water content decreased a nanofiber bundles size. This produced nanofiber bundles having a diameter of 2 μm (+/−10% according to normal measurement error and natural variation) with a separation between bundles of 1000 μm. In other words, the nanofiber diameter was less than 2% of the distance of separation between adjacent bundles (corresponding to the spacing designated as y in FIG. 10C). In an analogous experimental example, a nanofiber forest was prepared with spinnable strips with a dimension of 250 μm and non-spinnable region widths of 700 μm. These were drawn as described above and treated using, sequentially, a first solution of 80% water and 20% IPA followed by a second solution of 50% water and 50% IPA. The experimental results for samples treated either acetone or IPA as the final solvent appear below in Table 3.

TABLE 3

| | Bundle | Separation | Diameter/ |
|---|---|---|---|
| | Diameter | Distance | Separation |
| Final Solvent | (μm) | (μm) | Ratio |
| Acetone (sample 1) | 2.0 | 952 | 0.0021 |
| Acetone (sample 2) | 1.8 | 938 | 0.0019 |
| 100% IPA (sample 3) | 1.8 | 949 | 0.0019 |
| 100% IPA (sample 4) | 1.9 | 966 | 0.0020 |

In one example a nanofiber bundle in contact with, and transverse to, the nanofiber bundles of the grids described in the above table had a diameter of 2.5 μm.

In examples of nanofiber bundles and grids processed according to the method described in the context of FIGS. 10A-10C and bundled using the series of three solvents, can be treated to increase an electrical conductivity (or equivalently decrease a thermal resistance). In one example, nanoparticles of silver having a diameter of 50 nm or less can be applied to the bundles in a grid to produce a grid with an electrical resistance of 44 Ω/square. In one example, nanoparticles of silver having a diameter of 140 nm or less can be applied to the bundles in a grid to produce a grid with an electrical resistance of 10 Ω/square.

### Nanofiber Forests

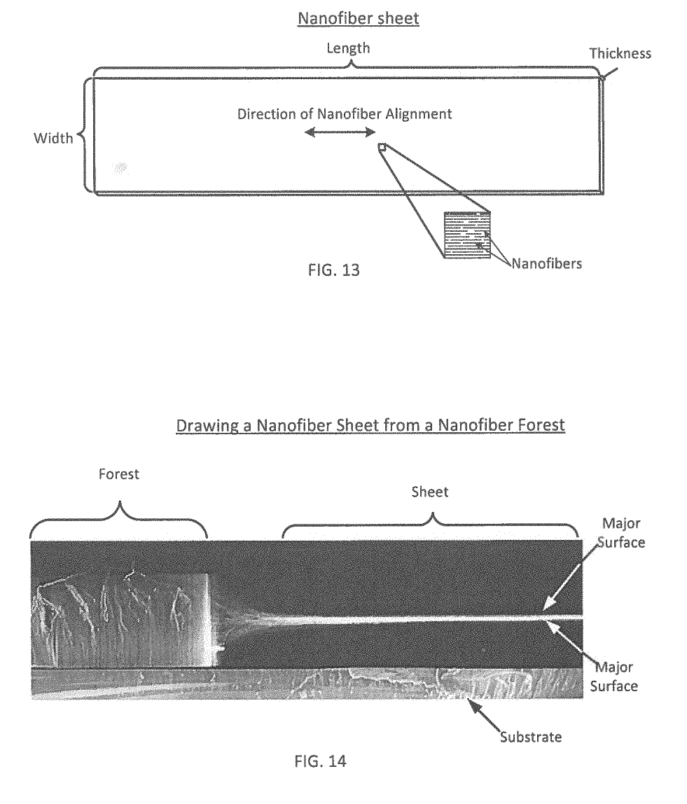

As used herein, the term “nanofiber” means a fiber having a diameter less than 1 μm. While the embodiments herein are primarily described as fabricated from carbon nanotubes, it will be appreciated that other carbon allotropes, whether graphene, and other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 13 and 14, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess unusual mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 11 shows an example forest of nanofibers on a substrate. The substrate may be any shape but in some embodiments the substrate has a planar surface on which the forest is assembled. As can be seen in FIG. 11, the nanofibers in the forest may be approximately equal in height and/or diameter.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 12. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO2, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 13 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 13, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some examples, carbon nanotubes (e.g., single walled carbon nanotubes, multiwalled carbon nanotubes, or a mixture of both) can be dispersed in a solvent, which is subsequently removed to form a nanofiber sheet of unaligned nanofibers. In some example embodiments, nanofiber sheets may be drawn from a nanofiber forest. An example of a nanofiber sheet being drawn from a nanofiber forest is shown in FIG. 14. Either of these types of nanofiber sheets can be used in any of the following embodiment in which a nanofiber sheet is placed in contact with one or more nanofiber webs and/or grids (as described below).

As can be seen in FIG. 14, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Further Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A method for processing a nanofiber sheet, the method comprising:
suspending in a frame at least two nanofiber sheets separated by a gap and having a first pitch; and
exposing the suspended nanofiber sheets to droplets of a solvent, wherein the exposing causes a freestanding portion of the suspended nanofiber sheets to contract into a bundle and be separated by a second pitch.

2. The method of claim 1, further comprising producing the at least two nanofiber sheets by treating a nanofiber forest, the treating comprising exposing nanofibers of the nanofiber forest to a laser to form a strip of treated nanofibers separating a first strip of untreated nanofibers and a second strip of untreated nanofibers, wherein the first strip of untreated nanofibers and the second strip of untreated nanofibers have the first pitch.

3. The method of claim 2, wherein the nanofibers exposed to the laser is not drawn into a nanofiber sheet.

4. The method of claim 2, wherein the gap is from 1 mm to 4 mm and the first pitch is from 1 mm to 4 mm.

5. The method of claim 2, wherein a ratio of a diameter of the bundle to the first pitch is from 0.003 to 0.005.

6. A method comprising:
treating a nanofiber forest to include a region of the nanofiber forest that cannot be drawn into a forest, the region separating a first strip and a second strip of the nanofiber forest at a first pitch;
drawing the first strip and the second strip into a first nanofiber sheet and a second nanofiber sheet at the first pitch;
mounting the first nanofiber sheet and the second nanofiber sheet onto a frame; and
exposing the first nanofiber sheet and the second nanofiber sheet to a solvent to form a first grid of a first nanofiber bundle and a second nanofiber bundle, the first nanofiber bundle and the second nanofiber bundle at a second pitch.

7. The method of claim 6, further comprising
repeating the method of claim 6 to form a second grid; and
placing the first grid on the second grid to form an assembly.

8. The method of claim 6, wherein:
the first pitch is from 0.5 mm to 1 cm; and
the second pitch is between 2000 μm to 2100 μm.

9. The method of claim 6, wherein the solvent is an aerosol of water, the exposing comprising using compressed air to form the aerosol of water.

10. A nanofiber assembly comprising:
a first nanofiber grid comprising a first nanofiber bundle and a second nanofiber bundle aligned with the first nanofiber bundle, the first nanofiber bundle having a first bundle average diameter and separated from the second nanofiber bundle by a first average pitch, the first nanofiber bundle having a ratio of a first bundle average diameter to the first average pitch of from 0.0001 to 0.0048;
a second nanofiber grid on the first nanofiber grid, the second nanofiber grid comprising a third nanofiber bundle aligned with a fourth nanofiber bundle, the third nanofiber bundle separated from the fourth nanofiber bundle by a second average pitch, the third nanofiber bundle having a second bundle average diameter and having a ratio of a second bundle average diameter to the second average pitch of from 0.0001 to 0.0048; and
a nanofiber sheet on the second nanofiber grid,
wherein an angle between the first nanofiber bundle and the third nanofiber bundle is between 30° and 90°.

11. The nanofiber assembly of claim 10, wherein the first average bundle diameter and the second bundle average diameter are each from 2 μm to 11 μm.

12. The nanofiber assembly of claim 10, wherein one or more of the first average pitch and the second average pitch is from 950 μm to 2400 μm.

13. The nanofiber assembly of claim 10, wherein:
one or more of the first average pitch and the second average pitch is from 935 μm to 975 μm; and
one or more of the first bundle average diameter and the second bundle average diameter is from 1.8 μm to 2.0 μm.

14. The nanofiber assembly of claim 10, wherein transmittance of radiation projected normally through the nanofiber assembly and having a wavelength of from 10 nm to 125 nm is more than 90%.

15. The nanofiber assembly of claim 10, wherein an intensity of transmitted radiation having a wavelength of from 10 nm to 125 nm has a 3σ variation over an area of the nanofiber assembly having a length of 100 mm and a width of 150 mm less than 0.5.

16. The nanofiber assembly of claim 10, wherein specular scattering of radiation having a wavelength of 13.5 nm is less than 1%.

17. The nanofiber assembly of claim 10, further comprising silver nanoparticles disposed within the first nanofiber bundle, the second nanofiber bundle, the third nanofiber bundle, and the fourth nanofiber bundle, the silver nanoparticles having a diameter of 50 nm or less.

18. The nanofiber assembly of claim 10, further comprising gaps defined by the second nanofiber grid on the first nanofiber grid having a dimension of from 10 μm to 25 μm.

19. The nanofiber assembly of claim 10, wherein transmittance through the nanofiber assembly of radiation having a wavelength of 550 nm is at least 86%.

20. The nanofiber assembly of claim 19, further comprising silver nanoparticles having an average diameter of from 100nm to 250 nm, and wherein the nanofiber assembly has a transmittance of 99% of radiation having a wavelength of 550 nm.
